(19) United States
(12) Patent Application Publication
(10) Pub. No.: US 2006/0107269 A1
(43) Pub. Date: May 18, 2006

(54) Virtual device hub

(75) Inventors: David F. Bantz, Portland, ME (US); Thomas E. Chefalas, Somers, NY (US); Steven J. Mastrianni, Unionville, CT (US); Clifford Alan Pickover, Yorktown Heights, NY (US)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 10/991,766

(22) Filed: Nov. 17, 2004

(51) Int. Cl. G06F 9/46

(52) U.S. Cl. 719/310

(57) ABSTRACT

A virtual device hub, into which local devices are plugged, enables those devices to be virtualized locally and with a remote virtual machine. Those devices then appear as available to the remote application, and can be used, for example, to print a report being processed on the remote host to a printer located at the user's physical location. The user's virtual device hub is a small computer device with network capability that is able to access the remote virtual machine. When the user runs an application, the application is actually being run in the remote virtual machine.

### FIELD OF THE INVENTION

The present invention relates to a system and method for virtualizing devices on a remote virtual machine and extending those devices to a user's physical location.

### BACKGROUND OF THE INVENTION

When a user is interacting with a system running on a virtual machine that exists in another location using a browser or thin client, the user has no direct access to local peripherals, only to those peripherals that exist on the remote host system, the virtual machine. Printing to a local printer or device, for example, is not possible. Adding a device to the system, and having the device recognized as available cannot be done from the remote location. For example, a user might want to directly scan a document at the user's own location using a peripheral scanner that is co-located with the user. In that case, the user would like his/her local (co-located) scanner to be able to interact with the virtual machine located remotely. This is o that the user can view and operate on the scanned data using the virtual machine that s/he is already running.

Normally, the virtual machine can only operate using devices that are local to that virtual machine itself, and the local user is forced to use only those devices that are currently installed on that virtual machine. A user installing a new peripheral device locally cannot immediately access it. As peripheral devices become more varied and portable (e.g., bluetooth connected PDA, portable digital music players), this problem becomes more acute.

The concept of virtual devices is itself not novel. In fact, even the virtual machine at the remote location virtualizes the devices attached to that system. Virtual device drivers virtualize the system's peripherals for each instance of a user accessing the virtual machine of the host system. For example, there may be only one printer installed on a particular virtual machine, yet any user accessing that virtual machine could print a document using that printer. The printer is a virtual device to those users because they access the device through the virtual machine. The virtual device driver mimics the actual hardware and lets the application in each virtual machine access the single physical device.

What is needed in the art is an apparatus and method whereby a user could access a local peripheral device while running a virtual machine.

### SUMMARY OF THE INVENTION

This invention resolves the above problem by providing a way for devices local to the user to be “plugged in”, recognized, and made available to the user while executing on the remote virtual machine. What makes this invention unique is that physically plugging a device into the user's local device hub allows the device to be detected locally, the device driver to be located, downloaded, and installed to the virtual machine. The device is thereby made available to the remotely located virtual machine instance that the user is currently executing.

The present invention relates to a system and method for virtualizing devices on a remote virtual machine and extending those devices to a user's physical location.

This invention provides for a virtual device hub, into which local peripherals or devices are plugged. Those devices are virtualized locally and with the remote virtual machine. Those devices then appear as available to the remote application, and can be used, for example, to print a report being processed on the remote host to a printer located at the user's physical location.

The user's virtual device hub is simply a small computer with network capability that is able to access the remote virtual machine. When the user runs an application, the application is actually being run in the remote virtual machine.

Output is directed to the user's display via the network connection, thus the local machine does not perform any of the processing, but simply operates like a thin client. Input from the user's keyboard is transmitted over the network to the user's virtual machine. Mouse movements are tracked at the user's local machine and sent to the remote virtual machine via the network. Changes in the display are sent from the remote virtual machine and rendered on the user's local system.

The user does not have to keep a local copy of the operating system environment, nor does the user have to keep the operating system environment up-to-date, virus free and with the proper security. The systems and administrators on the remove virtual machine insure that the virtual machine system is operating with the latest software.

The invention applies to physical machines as well. When applied to a physical machine, the operating system is enhanced through the provision of a device virtualization layer. The operating system itself supports device drivers that interact with abstract, virtualized devices, implemented by the device virtualization layer. The layer, in turn, implements communication with real devices through local device drivers or through device drivers that communicate with the device virtualization layer of some remote platform.

Certain devices require real-time response from their device drivers. For example, when a mouse is in use there is a maximum delay between movement of the mouse and the corresponding update to the display, otherwise the user will find the mouse unusable. The invention includes means, such as is known in the art, by which network quality-of-service (QoS) is negotiated so that these real-time response requirements can be met.

The virtual device hub may include storage devices, printers, audio/video equipment, media “burners,” projection equipment, room lights, telephony devices, cash-disbursement machines, TVs, and user interaction devices (e.g. trackball). If run as a service, fees may be charged as appropriate. The virtual device hub also handles certain aspects of security, scheduling, and compression. It can be queried to obtain information about available devices and guide the user as to how to best use the devices. The hub may be deployed in offices, malls, classrooms, and banks.

This concept goes beyond traditional computing devices and may apply to networked appliances in a kitchen, or networked components in any of an auto, a body area network (wearable computing), or telerobotics arena.

A principal object of the present invention is therefore, the provision of a system for virtualizing devices on a remote virtual machine and extending those devices to a user's physical location.

Another object of the present invention is the provision of a method for virtualizing devices on a remote virtual machine and extending those devices to a user's physical location.

A further object of the invention is the provision of a system, including a device virtualization layer, for virtualizing devices on a remote virtual machine and extending those devices to a user's physical location.

Further and still other objects of the present invention will become more clearly apparent when the following description is read in conjunction with the accompanying drawing.

### BRIEF DESCRIPTION OF THE DRAWINGS

FIG. 1 is a block diagram of a preferred embodiment of the present invention.

FIG. 2 is a flow chart of a method of performing the present invention.

FIG. 3 is a block diagram of a preferred embodiment of the present invention including a device virtualization layer.

### DETAILED DESCRIPTION

The present invention relates to a system and method for virtualizing devices on a virtual machine and extending those devices to a user's physical location.

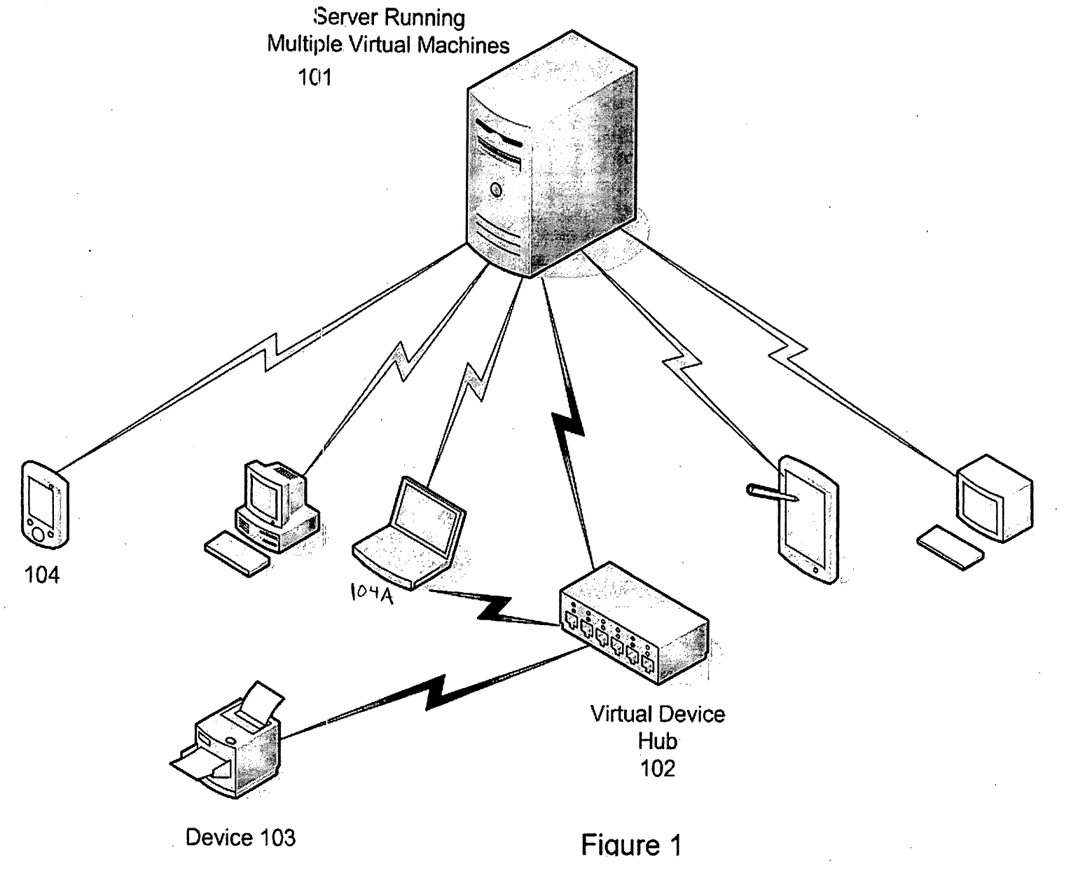

Referring now to the figures and to FIG. 1 in particular, a remote virtual machine (VM) in the server 101 virtializes the local peripheral devices 103 through the virtual device hub 102 and makes them available to the applications running remotely on the server 101.

When the user is operating a computing device 104 running a program located in a virtual machine on server 101, the user of the computing device 104 operates as if the operating system and application were resident on the computing device 104. The operating system and application, however, may exist in part or entirety on the remote server 101 and executing in the virtual machine instance of server 101.

A virtual device hub 102 of the invention is connected to a network that is capable of accessing the virtual machine running in the remote server 101. The connection from the virtual device hub 102 may be directly to the network that connects to the server 101, or the virtual device hub 102 may be connected to the server 101 through a Computing device 104A. The hub is “plugged in” to the server 101 through the virtual machine executing in the server 101.

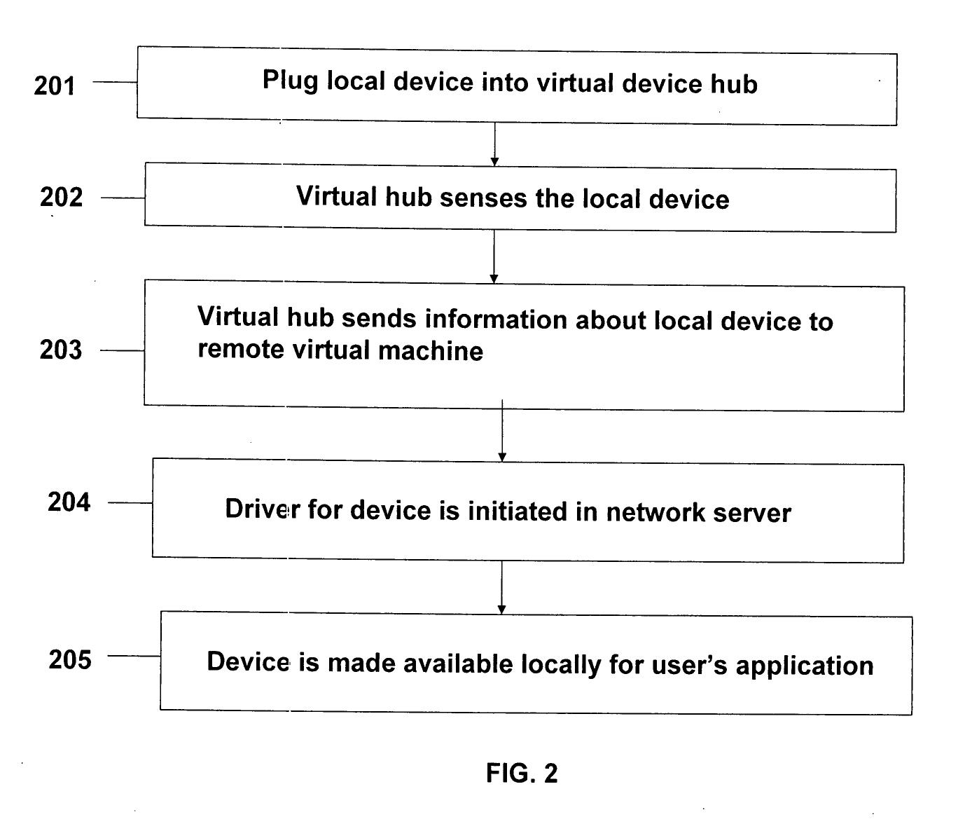

A method of practicing the invention is shown in FIG. 2 where when the user wishes to use a local device, the user plugs the local device into the virtual device hub in step 201. The virtual device hub senses that a device has been plugged into the hub in step 202, gathers the information about the device such as the device model number and type, and sends that information to the virtual machine instance in server in step 203.

The device information is used to allow the virtual machine to choose what type of device 103 has been inserted into the virtual device hub 102 in step 204, and to find out if support for that particular device exists on the server 101. If not, the virtual machine instance in the server 101 initiates the installation of a physical device driver in the server 101 and a virtual device driver in the virtual machine instance executing on the server 101. The device 103 is made available to the user's application via software in step 205.

When the user wishes to use a device 103 such as a printer, for example, the user interacts with the currently running application to print a file, for example, to the newly added printer 103. The user selects the local printer 103 for output and initiates the print operation. Since the application the user is running is actually located in the remote server 101, the application sends the print output to the virtual printer defined in the virtual machine instance on server 101. The output is then routed to the actual printer 103 through the network connection and the virtual device hub 102.

The application executing in the virtual machine in the server 101 understands that it has sent data to a printer 103 through a virtual device driver in the virtual machine (in the server 101). The virtual device driver in the virtual machine then routes the traffic over the network to the device hub 102. Thus the application in the server 101 “sees” the printer as a local device, when in fact it is a remote device located on a virtual device hub 102.

In certain isntances, the virtual machine (server 101) may allow other users, apart fro the one using the virtual device hub 102, to access and print to the printer that is plugged into the device hub 102. For example, the virtual machine (server 101) may have a policy allowing certain or all other users or virtual machines to share its devices, in which case those selected users/virtual machines could access the printer just as the local user.

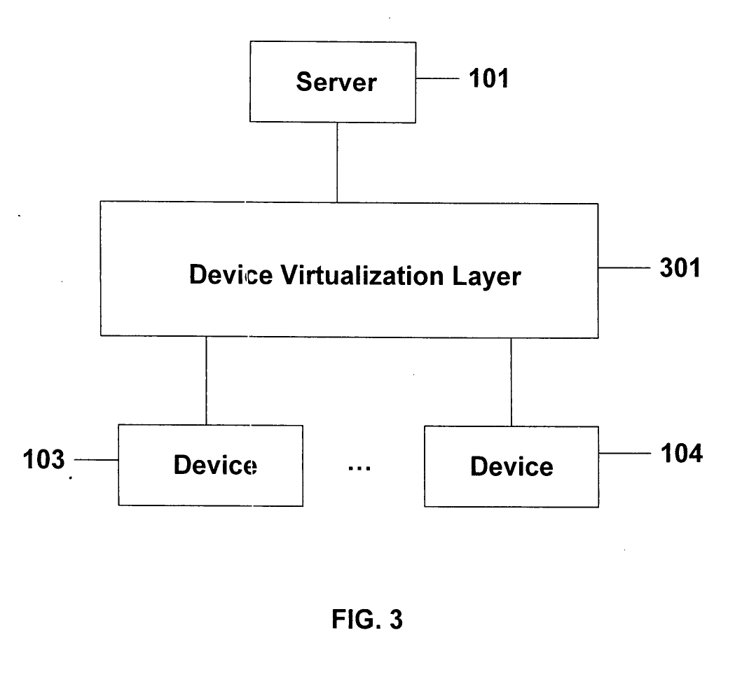

The invention is applicable to physical machines as well as virtual machines as shown in FIG. 3. When the invention is applied to a physical machine, a device virtualization layer 301 is interposed in the operating system between the device 103 and the server 101. The device virtualization layer 301 of a remote platform is provided in the operating system through local drivers or through device drivers that communicate between the physical device 103 and a remote platform.

While there has been described and illustrated a system and method for virtualizing devices on a remote virtual machine and extending those devices to a user's physical location, it will be apparent to those skilled in the art that variations and modifications are possible without deviating from the broad teachings and principles of the present invention which shall be limited solely by the broad scope of the claims appended hereto.

What is claimed is:

1. A method for virtualizing devices on a remote virtual machine and extending those devices to a user's physical location, comprising the steps of:
detecting that a device is available to a local client of a remote virtual machine;
sending information to the remote virtual machine that a device is available; and
making available locally the device.

2. A method for virtualizing devices on a remote virtual machine and extending those devices to a user's physical location as set forth in claim 1, further comprising the step of establishing communications between the remote virtual machine and the device.

3. A method for virtualizing devices on a remote virtual machine and extending those devices to a user's physical location as set forth in claim 1, where said making available locally comprises the remote virtual machine selecting and making available for download, software permitting the local client access and control of the device.

4. A method for virtualizing devices on a remote virtual machine and extending those devices to a user's physical location as set forth in claim 3, further comprising copying, downloading and installing the software.

5. A signal bearing medium tangibly embodying a program of machine-readable instructions executable by a digital processing apparatus to perform operations to virtualize devices on a remote virtual machine and extending those devices to a user's physical location, the operations comprising:
detecting that a device is available to a local client of a remote virtual machine;
sending information to the remote virtual machine that a device is available; and
making available locally the device.

6. A signal bearing medium tangibly embodying a program of machine-readable instructions executable by a digital processing apparatus to perform operations to virtualize devices on a remote virtual machine and extending those devices to a user's physical location, the operations comprising:
detecting that a device is available to a local client of a remote virtual machine;
sending information to the remote virtual machine that a device is available; and
making available locally the device by the remote virtual machine selecting and making available for download, software permitting the local client access and control of the device.

7. A signal bearing medium tangibly embodying a program of machine-readable instructions executable by a digital processing apparatus to perform operations to virtualize devices on a remote virtual machine and extending those devices to a user's physical location, the operations comprising:
detecting that a device is available to a local client of a remote virtual machine;
sending information to the remote virtual machine that a device is available;
making available locally the device by the remote virtual machine selecting and making available for download, software permitting the local client access and control of the device; and
copying, downloading and installing the software.

8. A system for virtualizing devices on a remote virtual machine and extending those devices to a user's physical location, comprising:
means for detecting that a device is available to a local client of a remote virtual machine;
means for sending information to the remote virtual machine that a device is available; and
means for making available locally the device.

9. A system for virtualizing devices on a remote virtual machine and extending those devices to a user's physical location as set forth in claim 8, further comprising means for establishing communications between the remote virtual machine and the device.

10. A system for virtualizing devices on a remote virtual machine and extending those devices to user's physical location as set forth in claim 8, where said means making available locally comprises means for the remote virtual machine selecting and making available for download, software permitting the local client access and control of the device.

11. A system for virtualizing devices on a remote virtual machine and extending those devices to a user's physical location as set forth in claim 10, further comprising means for copying, downloading and installing the software.

12. A system for virtualizing devices on a remote virtual machine and extending those devices to a user's physical location, comprising:
a server running one or more remote virtual machines;
a communications network; and
a virtual device hub capable of having a device plugged locally therein coupled to said server by means of said communications network.

13. A system for virtualizing devices on a remote virtual machine and extending those devices to a user's physical location as set forth in claim 12, where said virtual device hub comprises a computing device with network capability that is able to access at least one or the remote virtual machines.

14. A system for virtualizing devices on a remote virtual machine and extending those devices to a user's physical location as set forth in claim 12, where said virtual device hub is selected from the group consisting of storage devices, printers, audio/video equipment, media “burners,” projection equipment, room lights, telephony devices, cash-disbursement machines, TVs, and user interaction devices.

15. A system for virtualizing devices on a remote virtual machine and extending those devices to a user's physical location as set forth in claim 12, further comprising a virtual quality-of-service means for negotiating real-time response requirements for a device plugged locally in said virtual device hub.

16. A system for virtualizing devices on a remote machine and extending those devices to a user's physical location, comprising:
means for detecting that a device is available to a local client of a remote machine;
means for sending information to the remote machine that a device is available;
a device virtualization layer between said means for sending information and the remote machine; and
means for making available locally the device.

17. A system for virtualizing devices on a remote machine and extending those devices to a user's physical location as set forth in claim 16, where said device virtualization layer is provided in an operating system in the remote machine.

18. A system for virtualizing devices on a remote machine and extending those devices to a user's physical location as set forth in claim 16, where said means making available locally comprises means for the remote machine selecting and making available for download, software permitting the local client access and control of the device.

19. A system for virtualizing devices on a remote machine and extending those devices to a user's physical location as set forth in claim 18, further comprising means for copying, downloading and installing the software.

20. A system for virtualizing devices on a remote machine and extending those devices to a user's physical location as set forth in claim 16, further comprising means for establishing communications between the remote machine and the device.
